(19) United States
(12) Patent Application Publication
(10) Pub. No.: US 2020/0124167 A1
(43) Pub. Date: Apr. 23, 2020

(54) Shift Operation Device

(71) Applicant: Marelli Corporation, Saitama-shi, Saitama (JP)

(72) Inventor: Yoshinobu Fukuyama, Saitama-shi (JP)

(21) Appl. No.: 16/620,742

(22) PCT Filed: May 22, 2018
(86) PCT No.: PCT/JP2018/019681

§ 371 Date: Dec. 9, 2019

(30) Foreign Application Priority Data
Jun. 12, 2017 (JP) 2017-114819

(51) Int. Cl. F16H 59/10; B60K 23/00; G05G 1/04; G05G 25/04; F16H 59/02

(52) U.S. Cl. CPC F16H 59/10; B60K 23/00; F16H 59/0278; G05G 25/04; G05G 1/04

(57) ABSTRACT

A shift operation device includes a housing having an opening portion as a passage for a shift lever and a slide plate that covers the opening portion in a state in which the shift lever is inserted though the slide plate, and is slidable along the opening portion with movement of the shift lever, wherein the housing includes, in a side portion of the opening portion, a guide portion for displaying a shift position, the guide portion is provided with a position indicator that is movable together with the slide plate, the slide plate is integrally provided with an engagement piece that extends toward the guide portion, the engagement piece includes a hole, and the position indicator is provided with a guide bar that moves along the guide portion and is insertable/removable to/from the hole.

### CROSS-REFERENCE TO RELATED APPLICATION

The present application is based on and claims priority to Japanese Patent Application No. 2017-114819, filed on Jun. 12, 2017, the disclosure of which is hereby incorporated by reference in its entirety.

### TECHNICAL FIELD

This disclosure relates to a shift operation device.

### BACKGROUND

A vehicle such as an automobile includes a center console between a driver's seat and a front passenger's seat in a vehicle interior. In some of automobiles, a shift lever is installed in a front portion of the center console (see, for example, JP2001-22461A).

The shift lever is installed in the center console through a shift operation device. The shift operation device includes a housing having an opening portion as a passage for the shift lever and a slide plate that covers the opening portion in a state in which the shift lever is inserted through the slide plate. The slide plate is slidable along the opening portion with the movement of the shift lever.

The housing includes, in a side portion of the opening portion, a guide portion for displaying a shift position. A position indicator that is movable together with the slide plate is mounted on the guide portion.

### SUMMARY

However, the slide plate and the position indicator of the shift operation device described in JP2001-22461A can only move with a fixed height.

An object of the present disclosure is mainly to solve the above problem.

To solve the above problem, the present disclosure provides a shift operation device including a housing having an opening portion as a passage for a shift lever and a slide plate that covers the opening portion in a state in which the shift lever is inserted though the slide plate, and is slidable along the opening portion with movement of the shift lever, wherein the housing includes, in a side portion of the opening portion, a guide portion, the guide portion is provided with a position indicator that is movable together with the slide plate, the slide plate is integrally provided with an engagement piece that extends toward the guide portion, the engagement piece includes a hole, and the position indicator is provided with a guide bar that moves along the guide portion and is insertable/removable to/from the hole.

### BRIEF DESCRIPTION OF THE DRAWINGS

FIG. 1 is a plan view illustrating a shift operation device (a finisher plate located in a surface of the shift operation device) according to an embodiment;

FIG. 2 is a longitudinal sectional view of the shift operation device in FIG. 1;

FIG. 3 is a longitudinal sectional view of a housing in FIG. 2;

FIG. 4 is a perspective view of the housing in FIG. 3;

FIG. 5 is a perspective view of the shift operation device in which a display plate is attached to a guide portion of the housing in FIG. 4

FIG. 6 is an entire perspective view of a slide plate in FIG. 2

FIG. 7 is a partially enlarged view of FIG. 6;

FIG. 8 is a sectional view in a width direction, the view illustrating that a position indicator is mounted on the slide plate;

FIG. 9 is a sectional view in the width direction in a position A of FIG. 2;

FIG. 10 is a sectional view in the width direction in a position B of FIG. 2; and

FIG. 11 is a sectional view in the width direction in a position C of FIG. 2.

### DETAILED DESCRIPTION

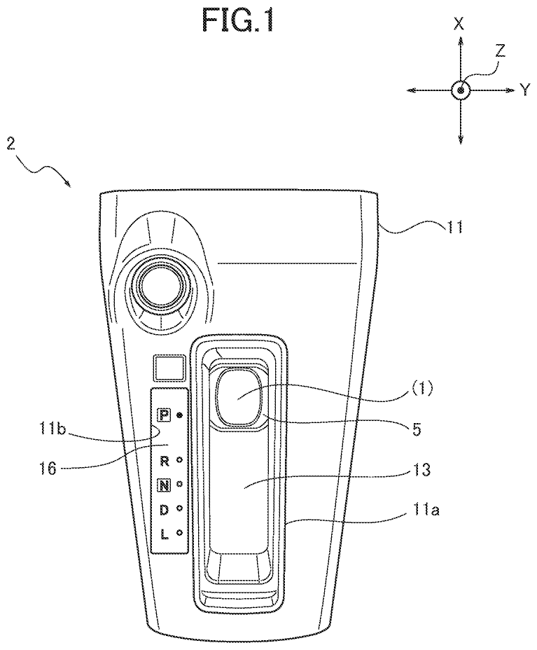

Hereinafter, an embodiment is described in details with reference to the drawings. FIGS. 1 to 11 describe the embodiment. In the drawings, X denotes a vehicle front and back direction, Y denotes a vehicle width direction, and Z denotes an up and down direction.

<Configuration>

Hereinafter, configurations of the embodiment are described.

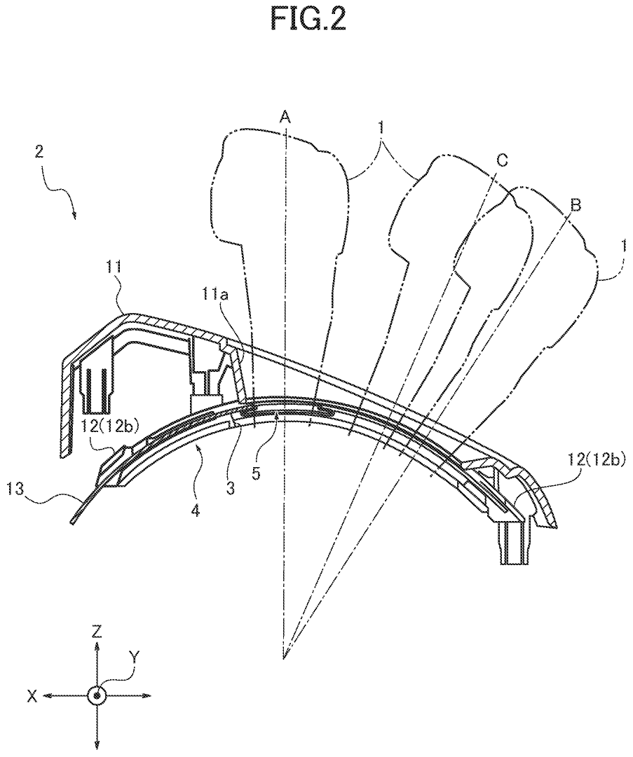

A vehicle such as an automobile includes a center console between a driver's seat and a front passenger's seat in a vehicle interior. As illustrated in FIGS. 1, 2, a shift lever 1 is installed in a front portion of the center console.

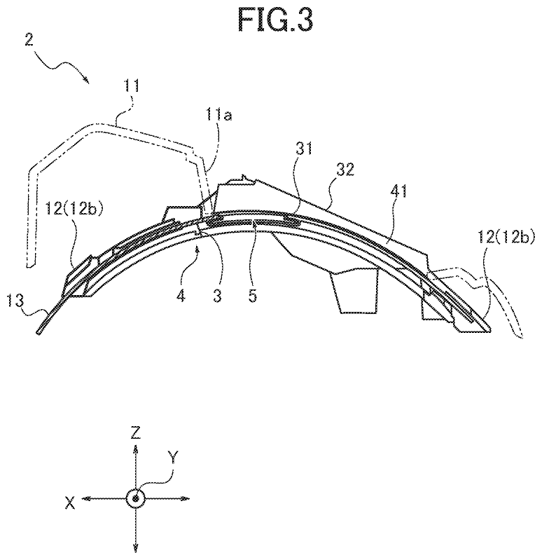

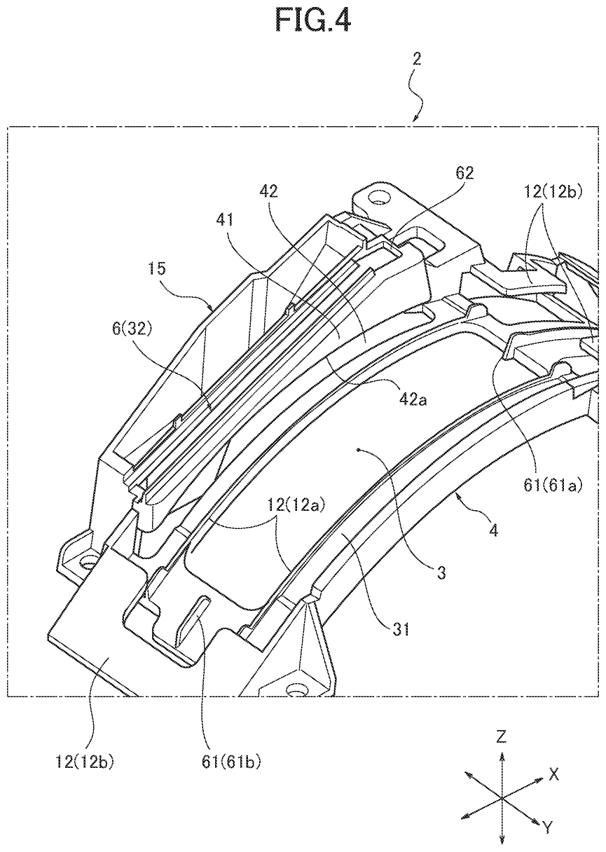

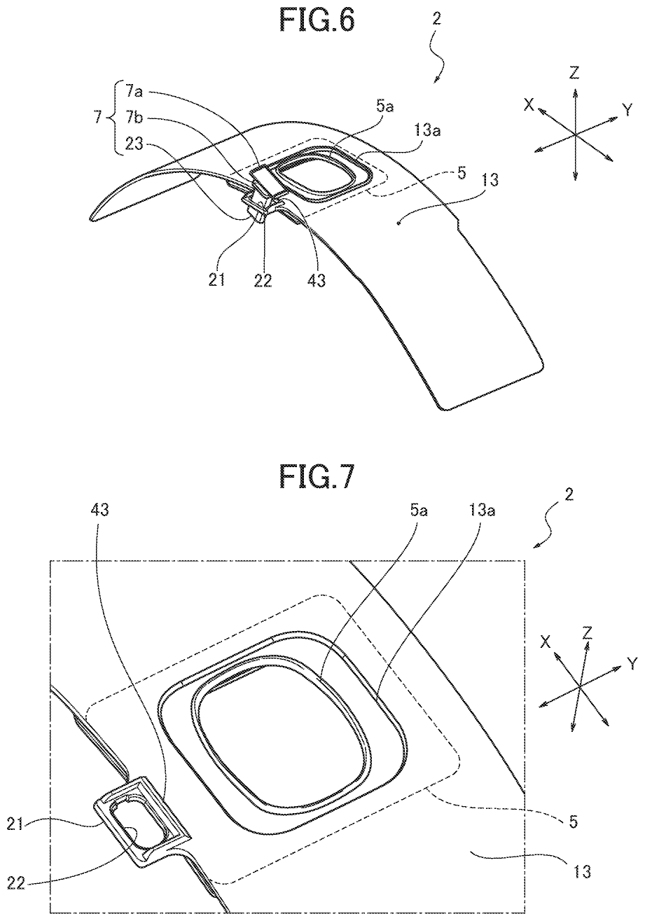

The shift lever 1 is installed in the center console through a shift operation device 2. The shift operation device 2 includes a housing 4 having an opening portion 3 as a passage for the shift lever 1, as illustrated in FIGS. 3 to 5 (mainly refer to FIG. 4), and a slide plate 5 that covers the opening portion 3 in a state in which the shift lever 1 is inserted through the slide plate 5, as illustrated in FIGS. 6, 7. The slide plate 5 is slidable along the opening portion 3 with the movement of the shift lever 1.

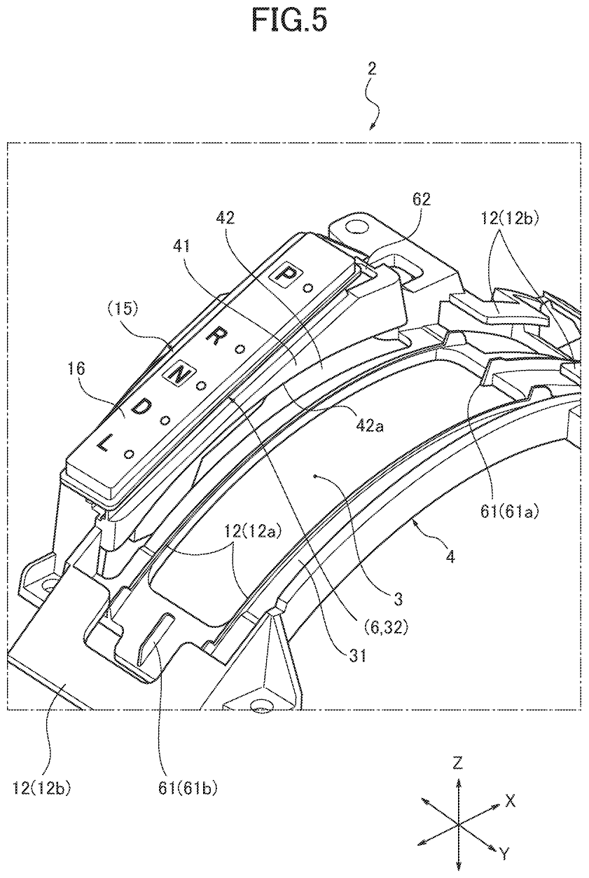

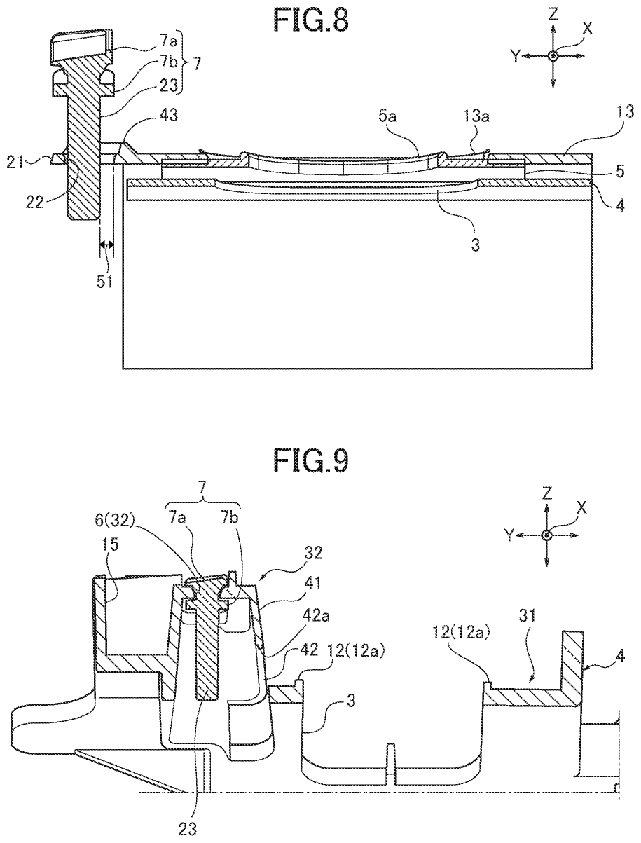

As illustrated in FIG. 4 (FIG. 5), the housing 4 includes, in a side portion of the opening portion 3, a guide portion 6 for displaying a shift position. As illustrated in FIG. 8 (to FIG. 11), a position indicator 7 that is movable together with the slide plate 5 is mounted on the guide portion 6.

The shift lever 1 includes a metal bar member (refer to FIG. 2), and projects from a finisher plate 11 (refer to FIG. 1) as a design surface of the shift operation device 2 toward the vehicle interior. The finisher plate 11 includes an opening portion 11a that surrounds a circumference of the opening portion 3 and an opening portion 11b that surrounds a circumference of the guide portion 6.

In this case, the opening portion 3 is a liner long hole, in a planar view, substantially extending in the vehicle front and back direction X (refer to FIG. 4).

The housing 4 is positioned below the finisher plate 11 (refer to FIG. 2). The housing 4 includes, around the opening portion 3, a plate guide portion 12 that guides the slide plate 5 (refer to FIG. 4). The plate guide portion 12 includes a side guide portion 12a that guides both side planes of the slide plate 5 and a front and back guide portion 12b that guides front and back positions of the slide plate 5 (a cover sheet 13 attached to the slide plate 5) from an upper side. The slide plate 5 (and cover sheet 13) is also guided by an undersurface of the finisher plate 11.

The slide plate 5 includes an opening portion 5a through which the shift lever 1 is inserted (refer to FIGS. 6, 7). The slide plate 5 integrally includes, on an upper surface thereof, a flexible strip-shaped cover sheet 13 extending in the vehicle front and back direction X at a required length, so as to cover the entire opening portion 3 even when the slide plate 5 is moved. The cover sheet 13 includes an opening portion 13a that surrounds a circumference of the opening portion 5a of the slide plate 5. The shift lever 1 is inserted through the opening portion 13a. The opening portion 13a has a size that is the same as or larger than that of the opening portion 5a.

The guide portion 6 is an indicator guide portion of a long hole, in a planar view, that is provided in the side portion of the opening portion 3 of the housing 4 to be parallel to the opening portion 3 (refer to FIG. 4). The guide portion 6 is shorter than the opening portion 3 in the vehicle front and back direction X by about a difference in length between the slide plate 5 and the position indicator 7. The guide portion 6 includes, in a side portion thereof facing away from the opening portion 3, a lamp housing 15 in which a light source for illumination is provided.

The position indicator 7 includes an index portion 7a that moves along the upper surface of the guide portion 6 (refer to FIGS. 8, 9). The index portion 7a is a flange that is engageable with the long hole of the guide portion 6 from above. The index portion 7a includes an upper surface as a colored portion colored by a conspicuous color such as red. The position indicator 7 includes a guide flange 7b that is engageable with an undersurface of the long hole of the guide portion 6 from below. The position indicator 7 integrally includes the index portion 7a and the guide flange 7b. The guide flange 7b and the index portion 7a include therebetween a shaft portion that passes through the guide portion 6. The shaft portion has an elliptical cross section extending in the vehicle front and back direction X.

A display plate 16 (or display lens) that displays a shift position is attached to upper portions of the guide portion 6 and the lamp housing 15 (refer to FIG. 5). The display plate 16 is a transparent member that can be illuminated by light from the light source provided in the lamp housing 15.

The embodiment includes the following configurations in addition to the above basic configurations.

(1) As illustrated in FIG. 6 (FIG. 7), the slide plate 5 is integrally provided with an engagement piece 21 extending toward the guide portion 6. The engagement piece 21 includes a hole 22. As illustrated in FIG. 8 (to FIG. 11), the position indicator 7 is provided with a guide bar 23 that is insertable/removable into/from the hole 22 while moving along the guide portion 6.

In this case, the engagement piece 21 is a tongue piece that projects from the side portion of the cover sheet 13. Alternatively, the engagement piece 21 may directly project from the side portion of the slide plate 5.

The hole 22 is provided in an approximate center portion of the engagement piece 21 in the vehicle front and back direction X and the vehicle width direction Y to be located below the guide portion 6. In this case, the hole 22 is a long hole extending in the extending direction of the guide portion 6.

The guide bar 23 extends downwardly from the undersurface of the lower guide flange 7b of the position indicator 7. The guide bar 23 includes a sectional shape such as an ellipse shape having the extending direction of the guide portion 6 as a longitudinal axis in accordance with the long hole 22. The position indicator 7 can thereby smoothly move without rotating or inclining along the guide portion 6.

(2) As illustrated in FIG. 3 (FIG. 4), the opening portion 3 and the guide portion 6 may be formed along two different planes 31, 32 which are nonparallel to each other.

The plane 31 of the opening portion 3 is a plane on which the slide plate 5 moves (hereinafter referred to as the first plane 31). The first plane 31 has, in a side view, a circular arc shape substantially projecting above.

The plane 32 of the guide portion 6 is a plane (hereinafter referred to as the second plane 32) on which the upper end portion (index portion 7a) of the position indicator 7 passes. The second plane 32 has, in a side view, a liner shape substantially inclining upward in the forward direction. However, the first plane 31 and the second plane 32 are not limited to these shapes.

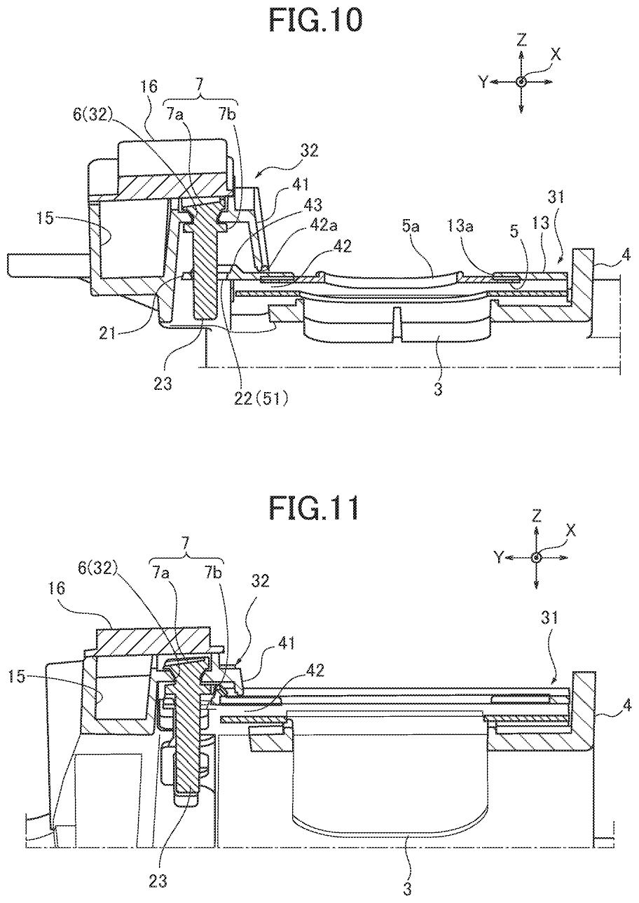

(3) As illustrated in FIG. 4, the first plane 31 in which the opening portion 3 is formed and the second plane 32 in which the guide portion 6 is formed may include therebetween a step portion 41. The second plane 32 is thus provided in a position higher than that of the first plane 31. The step portion 41 may be provided with a through hole 42 through which the engagement piece 21 is inserted. As illustrated in FIG. 10, a rib 43 for preventing water entry may be provided in at least a part of the circumference of the hole 22 of the engagement piece 21, which is close to the step portion 41. The rib 43 may be provided in a position that is the same as or higher than that of an upper edge portion 42a of the through hole 42.

The step portion 41 is a standing wall that connects the first plane 31 and the second plane 32. The step portion 41 includes respective portions each having a different height due to a difference in shape between the first plane 31 and the second plane 32.

The through hole 42 is provided in a lower portion of the step portion through which the engagement piece 21 passes. The through hole 42 is a long hole having a length which is the same as or slightly longer than a moving range of the engagement piece 21. The upper edge portion 42a of the through hole 42 is a downward end plane of the step portion 41.

The circumference of the hole 22 is an end portion of the hole 22 or a portion that surrounds outside the end portion of the hole 22.

The rib 43 may be provided in the entire circumference of the hole 22. In this case, the rib 43 has a C shape or a U shape, in a planar view, along three sides except for a leading end side of the engagement piece 21 (FIG. 7).

(4) As illustrated in FIG. 8, a clearance 51 for wastewater may be formed at least between a part of the circumference of the hole 22 of the engagement piece 21, which is close to the step portion 41, and the position indicator 7.

In this case, it is preferable for the clearance 51 to have a diameter larger than a diameter of a droplet.

(5) As illustrated in FIG. 4, the housing 4 may include, in an end portion of the opening portion 3, a stopper 61 that can regulate the moving range of the slide plate 5. An indicator detachable portion 62 at which the position indicator 7 can be attached may be provided in the guide portion 6 in a position which is outside the moving range of the position indicator 7.

The stopper 61 may be front and back stopper ribs 61a, 61b provided around the front and back end portions of the opening portion 3 in the housing 4. The stopper ribs 61a, 61b may be provided in a width center position of the opening portion 3.

The indicator detachable portion 62 may be provided in a front extended portion or a back extended portion of the guide portion 6 to be connected with the guide portion 6. The indicator detachable portion 62 is a hole portion having a size through which the flange index portion 7a provided in the upper end portion of the position indicator 7 does not passes, but the lower guide flange 7b passes. The position indicator 7 can be fitted into the indicator detachable portion 62 only when the slide plate 5 moves over the stopper 61.

<Operation> Hereinafter, the operations of the embodiment are described.

Upon moving the shift lever 1 forward or backward, the slide plate 5 moves forward or backward along the opening portion 3. At this time, the position indicator 7 housed in the hole 22 of the engagement piece 21 projecting from the slide plate 5 (integrated with the cover sheet 13) moves forward or backward along the guide portion 6. The shift position can be thereby indicated on the display plate 16.

<Effect> According to the embodiment, the following effects may be obtained.

(Effect 1) The engagement piece 21 of the slide plate 5 is provided with the hole 22, and the guide bar 23 of the position indicator 7 is insertably/removably housed in the hole 22. When the shift lever 1 is moved, the position indicator 7 moves together with the slide plate 5 in the moving direction of the shift lever 1. On the other hand, since the position indicator 7 is inserted/removed into/from the hole 22, the height of the position indicator 7 can be changed to be different from the slide plate 5. Accordingly, the slide plate 5 and the position indicator 7 can be moved at different heights, respectively. Thus, the shift operation device 2 is not limited to a specific design.

(Effect 2) The opening portion 3 and the guide portion 6 may be formed along the different nonparallel planes 31, 32. The shift operation device 2 can be thereby produced without being limited to a specific design.

(Effect 3) The through hole 42 may be provided in the step portion 41 between the first plane 31 in which the opening portion 3 is formed and the second plane 32 in which the guide portion 6 is formed. The engagement piece 21 can be thereby guided below the guide portion 6 through the through hole 42.

The rib 43 may be provided in at least a part of the circumference of the hole 22, which is close to the step portion 41. The rib 43 is provided in a position that is the same as or higher than that of the upper edge portion 42a of the through hole 42. A labyrinth seal is thereby formed between the step portion 41 and the rib 43. This labyrinth seal prevents the droplets of drink from entering the through hole 22 when the drink such as juice is spilled in the vehicle interior. The labyrinth seal thereby prevents the sticking of the droplets due to the entrance of the droplets between the hole 22 and the position indicator 7.

(Effect 4) The clearance 51 may be formed at least between a part of the circumference of the hole 22 of the engagement piece 21, which is close to the step portion 41, and the position indicator 7. The droplets which have entered between a part of the circumference of the hole 22 of the engagement piece 21, which is close to the step portion 41, and the position indicator 7 over the rib 43 can be drained downwardly through the clearance 51.

(Effect 5) The housing 4 may include, in the end portion of the opening portion 3, the stopper 61. The moving range of the slide plate 5 can be thereby regulated by the stopper 61.

The guide portion 6 may include the indicator detachable portion 62 outside the moving range. The position indicator 7 cannot be thereby attached/detached to/from the guide portion 6 in the moving range of the slide plate 5. The position indicator 7 can be thereby stably moved in the guide portion 6. The position indicator 7 cannot be thereby carelessly detached from the guide portion 6.

1. A shift operation device comprising:
a housing including an opening portion as a passage for a shift lever; and
a slide plate that covers the opening portion in a state in which the shift lever is inserted though the slide plate, and is slidable along the opening portion with movement of the shift lever, wherein
the housing includes, in a side portion of the opening portion, a guide portion for displaying a shift position,
the guide portion is provided with a position indicator that is movable together with the slide plate,
the slide plate is integrally provided with an engagement piece that extends toward the guide portion,
the engagement piece includes a hole,
the position indicator is provided with a guide bar that moves along the guide portion and is housed in the hole such that an insertion height of the guide bar is changeable with respect to the hole, and
the guide bar includes, in an upper portion thereof, a portion that is guided to the guide portion and, in a lower portion thereof, a portion in which the insertion height is changeable with respect to the hole.

2. The shift operation device according to claim 1, wherein
the opening portion and the guide portion are formed along two different planes that are nonparallel to each other.

3. The shift operation device according to claim 2, wherein
a first plane in which the opening portion is formed and a second plane in which the guide portion is formed include therebetween a step portion, and the second plane is provided in a position higher than that of the first plane,
the step portion includes a through hole through which the engagement piece is inserted,
a rib for preventing water entrance is provided in at least a part of a circumference of the hole of the engagement piece, which is close to the step portion, and
the rib is provided in a position that is a same as or higher than that of an upper end of the through hole.

4. The shift operation device according to claim 3, wherein
a clearance for wastewater is formed at least between the part of the circumference of the hole of the engagement piece, which is close to the step portion, and the position indicator.

5. The shift operation device according to claim 1, wherein
the housing includes, in an end portion of the opening portion, a stopper capable of regulating a moving range of the slide plate, and
the housing includes, outside the moving range of the position indicator in the guide portion, an indicator detachable portion at which the position indicator is attachable.
